(19) United States
(12) Patent Application Publication
(10) Pub. No.: US 2026/0195291 A1
(43) Pub. Date: Jul. 9, 2026

(54) I2C INTERFACE SYSTEM AND DATA READING/WRITING METHOD BASED ON AN I2C SLAVE DEVICE

(71) Applicant: NOREL SYSTEMS LIMITED, Tianjin (CN)

(72) Inventors: Yuanlong WANG, Tianjin (CN); Kuilin MOU, Tianjin (CN)

(21) Appl. No.: 19/556,211

(22) Filed: Mar. 4, 2026

Related U.S. Application Data
(63) Continuation of application No. PCT/CN2024/105907, filed on Jul. 17, 2024.

(30) Foreign Application Priority Data
Sep. 6, 2023 (CN) 202311142235.X

(51) Int. Cl. G06F 13/42; G06F 13/12; G06F 13/16

(52) U.S. Cl. CPC G06F 13/4291; G06F 13/126; G06F 13/1689

(57) ABSTRACT

The present invention provides an I2C interface system based on an I2C slave device, which comprises an I2C Master Controller, an I2C Slave Device, a first functional module, and a second functional module; the I2C Master Controller is connected to the I2C Slave Device via an I2C clock line and an I2C data line; the I2C Slave Device is connected to the first functional module and the second functional module. The present invention realizes supporting two modes of I2C data transmission (command packet transmission and operational data byte transmission) using only one I2C slave device, saves interface signals, and solves the problem of insufficient chip pins in small-package integrated circuits.

### CROSS-REFERENCE TO RELATED APPLICATION

This application ‎is a continuation application of International Patent Application No. ‎PCT/CN2024/105907, filed on July 17, 2024, which itself claims priority to and benefit ‎of Chinese Patent Application No. 202311142235.X, filed on September 6, 2023 in the State ‎Intellectual Property Office of P. R. China. The disclosure of each of the above applications ‎is incorporated herein by reference in its entirety.‎

### TECHNICAL FIELD

The present invention relates to the field of communication technology, and in particular to an I2C interface system and a data reading/writing method based on an I2C slave device.

### BACKGROUND ART

The I2C bus is a simple, bidirectional serial bus developed by Philips. Devices interconnected via the I2C bus are called I2C devices, and the interface through which an I2C device accesses the I2C bus is called an I2C interface. The I2C bus has become a de facto international standard, and the design specification of the I2C bus and its protocol (referred to as the standard I2C specification) is usually based on the description in the document "THE I2C-BUS SPECIFICATION VERSION 2.1 JANUARY 2000".

The I2C interface comprises an I2C clock line (generally named SCL) and an I2C data line (generally named SDA). The I2C Master Controller is connected to one or more I2C slave devices via the I2C clock line and I2C data line. The I2C Master Controller drives the I2C clock line, initiates I2C write operations or read operations, and judges whether the data transmission is successful through the acknowledgment bit. Bit errors occurring on the bus due to signal interference cannot be identified by the I2C slave device.

The electrical characteristics of the I2C interface require that devices participating in I2C communication share a common ground; otherwise, transmission cannot be performed. Therefore, I2C communication is not suitable for application scenarios with long transmission distances or strong signal interference. To solve this problem, a device for forwarding I2C data is usually added to the I2C bus, but the introduction of a forwarding device brings new problems:

The communication mechanism of I2C requires that each time the I2C Master Controller sends a byte, the I2C slave device must return an acknowledgment bit. A low level of the acknowledgment bit is an I2C ACK, and a high level is an I2C NAK.

In the existing I2C communication mechanism, one mode is to transmit I2C data in the form of command packets, and the other mode is to transmit I2C data in the form of operational data bytes, that is, each byte sent by the I2C Master Controller is transmitted to the final data-receiving module (referred to as a functional module in the present invention), and the functional module generates an acknowledgment bit and returns it to the I2C Master Controller. The advantage of transmitting I2C data in the form of command packets is high speed, especially for long-distance transmission. The advantage of transmitting I2C data in the form of operational data bytes is good compatibility, which is compatible with all current I2C Master Controllers without any modification, but the disadvantage is low speed.

In the prior art, two I2C interfaces (two I2C slave devices) are required to support the two I2C data transmission modes, which respectively support the command packet transmission mode and the operational data byte transmission mode. The use of two I2C interface signals results in waste of interface signals and the problem of insufficient chip pins in small-package integrated circuits.

### SUMMARY

To solve the problems of waste of interface signals and insufficient chip pins in small-package integrated circuits caused by using two I2C interfaces to respectively support the command packet transmission mode and the operational data byte transmission mode in the prior art, one object of the present invention is to provide an I2C interface system based on an I2C slave device. The I2C interface system comprises an I2C Master Controller, an I2C Slave Device, a first functional module, and a second functional module;

The I2C Master Controller is connected to the I2C Slave Device via an I2C clock line and an I2C data line; the I2C Slave Device is connected to the first functional module and the second functional module.

Another object of the present invention is to provide a data reading and writing method based on an I2C slave device, characterized by using the I2C interface system based on an I2C slave device provided by the present invention for data reading and writing, comprising:

The I2C Master Controller initiates a first I2C write operation and a second I2C write operation, wherein the first I2C write operation comprises a first write address byte and first write operation data, the first write operation data comprises a command packet; the second I2C write operation comprises a second write address byte and second write operation data; both the first write address byte and the second write address byte comprise an I2C write address and a write operation indicator bit;

When the I2C write address received by the I2C Slave Device meets a first preset condition, the I2C Slave Device receives the command packet sent by the first I2C write operation, and after receiving the command packet, sends the command packet to the first functional module;

The first functional module receives the command packet and executes the command, and after completing the command, returns a feedback packet to the I2C Slave Device; the I2C Slave Device returns the information contained in the feedback packet to the I2C Master Controller;

When the I2C write address received by the I2C Slave Device meets a second preset condition, the I2C Slave Device receives the second I2C write operation, and after receiving each byte of the second write operation, sends each received byte of the second write operation to the second functional module;

After receiving each byte of the second write operation, the second functional module returns a second write status packet to the I2C Slave Device;

When the I2C Slave Device receives the second write status packet and the status information of the second write status packet is successful, the I2C Slave Device returns an I2C ACK to the I2C Master Controller;

When the I2C Slave Device receives the second write status packet and the status information of the second write status packet is failed, the I2C Slave Device returns an I2C NAK to the I2C Master Controller.

Preferably, the command packet received by the I2C Slave Device is a write command packet, and after receiving the write command packet, the I2C Slave Device pulls down the level of the I2C clock line and sends the write command packet to the first functional module;

The first functional module receives the write command packet and executes the write command, and after completing the write command, the feedback packet returned to the I2C Slave Device is a first write status packet; the information contained in the feedback packet is the status information of the first write status packet, and the I2C Slave Device returns the status information of the first write status packet to the I2C Master Controller.

Preferably, the I2C Slave Device returns the status information of the first write status packet to the I2C Master Controller, comprising:

When the I2C Slave Device receives the first write status packet and the status information of the first write status packet is successful, the I2C Slave Device stops pulling down the level of the I2C clock line and returns an I2C ACK to the I2C Master Controller;

When the I2C Slave Device receives the first write status packet and the status information of the first write status packet is failed, the I2C Slave Device stops pulling down the level of the I2C clock line and returns an I2C NAK to the I2C Master Controller.

Preferably, the command packet received by the I2C Slave Device is a write command packet, and after receiving the write command packet, the I2C Slave Device sends the write command packet to the first functional module;

The first functional module receives the write command packet and executes the write command, and after completing the write command, the feedback packet returned to the I2C Slave Device is a first write status packet; the information contained in the feedback packet is the status information of the first write status packet, and the I2C Slave Device returns the status information of the first write status packet to the I2C Master Controller, comprising:

After the I2C Slave Device receives the write command packet,

If the subsequent I2C operation initiated by the I2C Master Controller is a first I2C write operation, and the I2C Slave Device receives the first write status packet returned by the first functional module and the status information of the first write status packet is successful, the I2C Slave Device receives the subsequent first I2C write operation initiated by the I2C Master Controller;

If the subsequent I2C operation initiated by the I2C Master Controller is a first I2C write operation, and the I2C Slave Device receives the first write status packet returned by the first functional module and the status information of the first write status packet is failed, the I2C Slave Device returns an I2C NAK to the I2C Master Controller;

If the subsequent I2C operation initiated by the I2C Master Controller is a first I2C read operation, and the I2C Slave Device receives the first write status packet returned by the first functional module, the I2C Slave Device returns the status information of the first write status packet to the I2C Master Controller.

Preferably, the command packet received by the I2C Slave Device is a read command packet, and after receiving the read command packet, the I2C Slave Device pulls down the level of the I2C clock line and sends the read command packet to the first functional module;

The first functional module receives the read command packet and executes the read command, and after completing the read command, the feedback packet returned to the I2C Slave Device is a first read data packet, and the information contained in the feedback packet is the read data in the first read data packet; the I2C Slave Device returns the read data in the first read data packet to the I2C Master Controller.

Preferably, the I2C Slave Device returns the read data in the first read data packet to the I2C Master Controller, comprising:

When the I2C Slave Device receives the first read data packet, the I2C Slave Device stops pulling down the level of the I2C clock line;

If the subsequent I2C operation initiated by the I2C Master Controller is a first I2C read operation, the I2C Slave Device returns the read data in the first read data packet to the I2C Master Controller.

Preferably, the command packet received by the I2C Slave Device is a read command packet, and after receiving the read command packet, the I2C Slave Device sends the read command packet to the first functional module;

The first functional module receives the read command packet and executes the read command, and after completing the read command, the feedback packet returned to the I2C Slave Device is a first read data packet, and the information contained in the feedback packet is the read data in the first read data packet; the I2C Slave Device returns the read data in the first read data packet to the I2C Master Controller, comprising:

After the I2C Slave Device receives the read command packet,

If the subsequent I2C operation initiated by the I2C Master Controller is a first I2C read operation, and the I2C Slave Device receives the first read data packet returned by the first functional module, the I2C Slave Device returns the read data in the first read data packet to the I2C Master Controller.

Preferably, the second functional module is further connected to a remote I2C slave device, and after the I2C Slave Device receives the second write address byte, it sends the received second write address byte to the second functional module;

After receiving the second write address byte, the second functional module sends an I2C START signal and the second write address byte to the remote I2C slave device, and receives an I2C ACK or I2C NAK returned by the remote I2C slave device to the second functional module;

If the remote I2C slave device returns an I2C ACK to the second functional module, the status information of the second write status packet returned by the second functional module to the I2C Slave Device is successful;

If the remote I2C slave device returns an I2C NAK to the second functional module, the status information of the second write status packet returned by the second functional module to the I2C Slave Device is failed.

Preferably, the second functional module is further connected to a remote I2C slave device, and after receiving each byte of the second write operation data, the second functional module sends each received byte of the second write operation data to the remote I2C slave device, and after sending each byte of the second write operation data, receives an I2C ACK or I2C NAK returned by the remote I2C slave device to the second functional module;

If the remote I2C slave device returns an I2C ACK to the second functional module, the status information of the second write status packet returned by the second functional module to the I2C Slave Device is successful;

If the remote I2C slave device returns an I2C NAK to the second functional module, the status information of the second write status packet returned by the second functional module to the I2C Slave Device is failed.

Preferably, the second functional module is further connected to a remote I2C slave device, and the I2C Master Controller can also send an I2C STOP signal to the I2C Slave Device;

After receiving the I2C STOP signal, the I2C Slave Device sends the I2C STOP signal to the remote I2C slave device via the second functional module.

Another object of the present invention is to provide a data reading and writing method based on an I2C slave device, using the I2C interface system based on an I2C slave device of the present invention for data reading and writing, comprising:

The I2C Master Controller initiates a first I2C read operation and a second I2C read operation, wherein the first I2C read operation includes a first read address byte and first read operation data; the second I2C read operation includes a second read address byte and second read operation data; both the first read address byte and the second read address byte include an I2C read address and a read operation indicator bit;

When the I2C read address received by the I2C Slave Device meets a third preset condition, the I2C Slave Device receives the first I2C read operation and returns the first read operation data to the I2C Master Controller;

When the I2C read address received by the I2C Slave Device meets a fourth preset condition, the I2C Slave Device receives the second I2C read operation, and after receiving the second read address byte, sends the received second read address byte to the second functional module;

After receiving the second read address byte, the second functional module returns a second read data packet to the I2C Slave Device; wherein the second read data packet includes status information and/or one byte of second read operation data;

When the I2C Slave Device receives the second read data packet and the information status of the second read data packet is failed, the I2C Slave Device returns an I2C NAK to the I2C Master Controller;

When the I2C Slave Device receives the second read data packet containing one byte of second read operation data, the I2C Slave Device returns an I2C ACK and one byte of second read operation data to the I2C Master Controller;

After the I2C Master Controller receives one byte of second read operation data, it sends an I2C ACK or I2C NAK to the I2C Slave Device;

The I2C Slave Device sends the received I2C ACK or I2C NAK from the I2C Master Controller to the second functional module;

After the second functional module receives the I2C ACK, it returns a second read data packet containing one byte of second read operation data to the I2C Slave Device; after receiving the second read data packet containing one byte of second read operation data, the I2C Slave Device returns one byte of second read operation data to the I2C Master Controller.

Preferably, the second functional module is further connected to a remote I2C slave device, and when the I2C read address received by the I2C Slave Device meets the fourth preset condition, the I2C Slave Device receives the second I2C read operation, and after receiving the second read address byte, sends the received second read address byte to the second functional module;

After receiving the second read address byte, the second functional module sends an I2C START signal and the second read address byte to the remote I2C slave device, and receives an I2C ACK or I2C NAK returned by the remote I2C slave device to the second functional module;

If the remote I2C slave device returns an I2C NAK to the second functional module, the information status of the second read data packet returned by the second functional module to the I2C Slave Device is failed;

If the remote I2C slave device returns an I2C ACK to the second functional module, the second functional module reads one byte of second read operation data from the remote I2C slave device and returns a second read data packet containing one byte of second read operation data to the I2C Slave Device.

Preferably, the I2C Slave Device sends the received I2C ACK or I2C NAK from the I2C Master Controller to the second functional module;

After the second functional module receives the I2C ACK, it sends an I2C ACK to the remote I2C slave device, reads one byte of second read operation data from the remote I2C slave device, and returns a second read data packet containing one byte of second read operation data to the I2C Slave Device.

Preferably, the I2C Slave Device sends the received I2C ACK or I2C NAK from the I2C Master Controller to the second functional module;

After the second functional module receives the I2C NAK, it sends an I2C NAK to the remote I2C slave device.

Preferably, when the I2C read address received by the I2C Slave Device meets the fourth preset condition, the I2C Slave Device receives the second I2C read operation, and after receiving the second read address byte, sends the received second read address byte to the second functional module;

After receiving the second read address byte, the second functional module returns a second read data packet with failed status information to the I2C Slave Device, or after receiving the second read address byte, returns a second read data packet with successful status information and a second read data packet containing one byte of second read operation data to the I2C Slave Device.

Preferably, the second functional module is further connected to a remote I2C slave device, and when the I2C read address received by the I2C Slave Device meets the fourth preset condition, the I2C Slave Device receives the second I2C read operation, and after receiving the second read address byte, sends the received second read address byte to the second functional module;

After receiving the second read address byte, the second functional module sends an I2C START signal and the second read address byte to the remote I2C slave device, and receives an I2C ACK or I2C NAK returned by the remote I2C slave device to the second functional module;

If the remote I2C slave device returns an I2C NAK to the second functional module, the second functional module returns a second read data packet with failed information status to the I2C Slave Device;

If the remote I2C slave device returns an I2C ACK to the second functional module, the second functional module returns a second read data packet with successful status information to the I2C Slave Device,

and the second functional module reads one byte of second read operation data from the remote I2C slave device,

and the second functional module returns a second read data packet containing one byte of second read operation data to the I2C Slave Device.

Preferably, the functions of the second functional module and the first functional module can be integrated into the same module.

The I2C interface system and data reading/writing method based on an I2C slave device provided by the present invention realize supporting two modes of I2C data transmission (command packet transmission and operational data byte transmission) using only one I2C slave device, save interface signals, and solve the problem of insufficient chip pins in small-package integrated circuits.

### BRIEF DESCRIPTION OF DRAWINGS

To more clearly illustrate the specific embodiments of the present invention or the technical solutions in the prior art, the following will briefly introduce the drawings needed in the description of the specific embodiments or the prior art. Obviously, the drawings in the following description are some embodiments of the present invention. For those of ordinary skill in the art, other drawings can be obtained according to these drawings without creative work.

FIG. 1 schematically shows a schematic diagram of an I2C interface system based on an I2C slave device of the present invention.

FIG. 2 shows a timing diagram of an I2C write operation of the present invention.

FIG. 3 shows a timing diagram of an I2C read operation of the present invention.

FIG. 4 shows a timing diagram of a continuous I2C read/write operation of the present invention.

FIG. 5 shows a timing diagram of an I2C Master Controller initiating an I2C write operation of the present invention.

FIG. 6 shows a timing diagram in which the I2C Master Controller initiates a first I2C write operation to send a write command packet and the status information of the first write status packet is successful in the first mode of the present invention.

FIG. 7 shows a timing diagram in which the I2C Master Controller initiates a first I2C write operation to send a write command packet and the status information of the first write status packet is failed in the first mode of the present invention.

FIG. 8 shows a timing diagram in which the I2C Master Controller initiates a first I2C write operation to send a write command packet and the status information of the write status packet is successful in the second mode of the present invention.

FIG. 9 shows a timing diagram in which the I2C Master Controller initiates a first I2C write operation to send a write command packet and the status information of the write status packet is failed in the second mode of the present invention.

FIG. 10 shows a timing diagram in which the I2C Master Controller initiates a first I2C write operation to send a write command packet and receives an I2C read operation in the second mode of the present invention.

FIG. 11 shows a timing diagram in which the I2C Master Controller initiates a first I2C write operation to send a read command packet and the subsequent I2C operation is a first I2C read operation in the third mode of the present invention.

FIG. 12 shows a timing diagram in which the I2C Master Controller initiates a first I2C write operation to send a read command packet and the subsequent I2C operation is a first I2C read operation in the fourth mode of the present invention.

FIG. 13 shows a timing diagram in which the I2C Master Controller initiates a second I2C write operation and the I2C Slave Device receives the second write operation of the present invention.

FIG. 14 shows a timing diagram in which the I2C Master Controller initiates a second I2C read operation and the second read data packet returned by the second functional module to the I2C Slave Device after receiving the second read address byte contains one byte of second read operation data of the present invention.

FIG. 15 shows a timing diagram in which the I2C Master Controller initiates a second I2C read operation and the status information of the second read data packet returned by the second functional module to the I2C Slave Device after receiving the second read address byte is failed of the present invention.

FIG. 16 shows a timing diagram in which the I2C Master Controller initiates a second I2C read operation and the second functional module returns a second read data packet with successful status information and a second read data packet containing one byte of second read operation data to the I2C Slave Device after receiving the second read address byte of the present invention.

The meanings of the text identifiers in the above drawings are as follows:

100: I2C Master Controller; 200: I2C Slave Device; 300: First functional module; 400: Second functional module; 500: Remote I2C slave device; 600: I2C data line (SDA); 700: I2C clock line (SCL);

S: Indicates an I2C START signal, and the corresponding I2C bus state is that when SCL is at a high level, SDA has a transition from high level to low level;

P: Indicates an I2C STOP signal, and the corresponding I2C bus state is that when SCL is at a high level, SDA has a transition from low level to high level;

Sr: The corresponding I2C bus state is the same as S;

Sr/P: The corresponding I2C bus state is Sr or P;

ADDR: I2C address (I2C write address or I2C read address);

R/W: Indicates a read/write operation indicator bit. When this bit is R, it indicates a current I2C read operation; when this bit is W, it indicates a current I2C write operation;

R: Indicates a read operation indicator bit, and the corresponding I2C bus state is that SDA is at a high level during the period when SCL is at a high level;

W: Indicates a write operation indicator bit, and the corresponding I2C bus state is that SDA is at a low level during the period when SCL is at a high level;

BYTE: Write operation data or read operation data, usually a multi-byte sequence. The content in parentheses after it indicates the sequence number of the byte in the sequence. The write command packet or read command packet is sent through the write operation data, and the read data or status information is read through the read operation data. The byte with a smaller sequence number is sent first;

A: Indicates an I2C ACK, and the corresponding I2C bus state is that SDA is always at a low level during the period when SCL is at a high level;

N: Indicates an I2C NAK, and the corresponding I2C bus state is that SDA is always at a high level during the period when SCL is at a high level;

DATA: A sequence consisting of bytes containing read data and I2C ACK/I2C NAK between bytes;

STATUS: A sequence consisting of bytes containing status information and I2C ACK/I2C NAK between bytes;

A/N: The corresponding I2C bus state is that SDA is always at a high level or always at a low level during the period when SCL is at a high level;

HOLD: SCL is at a continuous low level;

IDLE: The corresponding I2C bus state includes the following two possibilities:

(1) Both SCL and SDA are at high levels;

(2) SCL and SDA may have other level states, but there is no legal I2C operation in the combination of these level states. When IDLE is about to end, both SCL and SDA are at high levels.

### DETAILED DESCRIPTION OF EMBODIMENTS

To make the above and other features and advantages of the present invention more clear, the present invention will be further described below with reference to the accompanying drawings. It should be understood that the specific embodiments provided herein are for the purpose of explaining to those skilled in the art, and are merely exemplary rather than restrictive.

The clock line (SCL) and the I2C data line (SDA) are collectively referred to as the I2C bus. The I2C bus has become a de facto international standard. The design specification of the I2C bus and its protocol (referred to as the standard I2C specification) is usually based on the description in the document "THE I2C-BUS SPECIFICATION VERSION 2.1 JANUARY 2000".

As shown in FIG. 1, according to an embodiment of the present invention, an I2C interface system based on an I2C slave device is provided, comprising an I2C Master Controller 100, an I2C Slave Device 200, a first functional module 300, and a second functional module 400.

The I2C Master Controller 100 is connected to the I2C Slave Device 200 via an I2C clock line (SCL) 700 and an I2C data line (SDA) 600. The I2C Slave Device 200 is connected to the first functional module 300, and the I2C Slave Device 200 is connected to the second functional module 400.

The first functional module 300 and the second functional module 400 of the present invention may be modules with different functions (thus two modules physically) or modules with the same function (at this time, they may be two modules physically or one module physically). The first functional module 300 and the second functional module 400 are only for convenience of description, and may be two modules with different functions, two modules with the same function, or one module with the same function.

The embodiment shown in FIG. 1 further comprises a remote I2C slave device 500; the second functional module 400 is connected to the remote I2C slave device 500.

In other embodiments of the present invention, the remote I2C slave device 500 may not be included, and the second functional module 400 is not connected to the remote I2C slave device 500.

The embodiment shown in FIG. 1 comprises one first functional module 300 and one second functional module 400. In other embodiments of the present invention, the number of the first functional module 300 and the second functional module 400 may also be multiple. In the following embodiments, one first functional module 300 and one second functional module 400 are taken as examples for description.

One I2C Master Controller 100 can be connected to one or more I2C Slave Devices 200 via the same I2C bus (clock line 500 and I2C data line 400), and transmit a byte sequence carrying information through an I2C read operation or an I2C write operation. In this embodiment, one I2C Master Controller 100 is connected to one I2C Slave Device 200 via the same I2C bus (I2C clock line (SCL) 700 and I2C data line (SDA) 600) as an example for description.

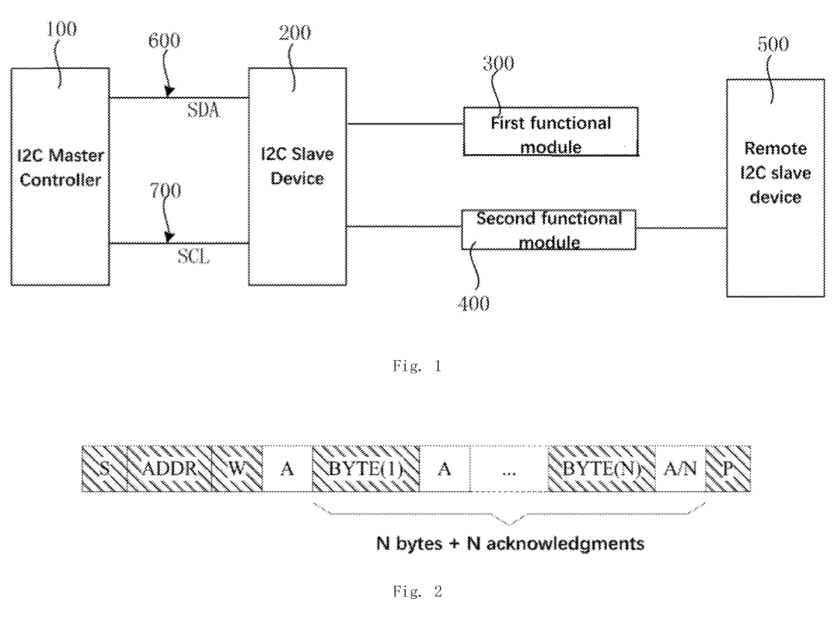

As shown in FIG. 2, an I2C write operation includes a write address byte and one or more write operation data bytes (BYTE (1), ..., BYTE (N), shaded). The write address byte is the first byte sent, and the write address byte includes an I2C write address (ADDR) and a write operation indicator bit (W). According to the standard I2C specification, the write operation indicator bit (W) is at a low level.

In this embodiment, both the write address byte and the write operation data byte are 8 bits, wherein the write address byte includes a 7-bit I2C write address (ADDR) and a 1-bit write operation indicator bit (W). The present invention does not limit the number of bits of the write address byte and the write operation data byte. In other embodiments, the write address byte and the write operation data byte may have other numbers of bits.

When the I2C Master Controller 100 initiates an I2C write operation, the I2C Master Controller 100 first drives the I2C clock line (SCL) 700 and the I2C data line (SDA) 600 according to the standard I2C specification to generate an I2C START signal (S), then sends the write address byte. After receiving the write address byte, the I2C Slave Device 200 drives the I2C data line (SDA) 600 to generate an acknowledgment bit. According to the standard I2C specification, the acknowledgment bit can be an I2C ACK (the level of the I2C data line (SDA) 600 is low) or an I2C NAK (the level of the I2C data line (SDA) 600 is high).

When the acknowledgment bit of the write address byte is an I2C ACK, the I2C Master Controller 100 can send one or more write operation data bytes. After receiving each write operation data byte, the I2C Slave Device 200 drives the I2C data line (SDA) 600 to generate an acknowledgment bit. The acknowledgment bit of the write operation data byte can be an I2C ACK (the level of the I2C data line (SDA) 600 is low) or an I2C NAK (the level of the I2C data line (SDA) 600 is high).

According to the standard I2C specification, when sending the write address byte and one or more write operation data bytes, the I2C Master Controller 100 sends the number of bits contained in the write address byte and the write operation data byte by driving the I2C data line (SDA) 600, and for each bit contained in the write address byte and the write operation data byte, the I2C Master Controller 100 drives the I2C clock line (SCL) 700 to generate a clock pulse.

According to the standard I2C specification, corresponding to the acknowledgment bit of the write address byte and the acknowledgment bit of the write operation data byte, the I2C Master Controller 100 also drives the I2C clock line (SCL) 700 to generate a clock pulse. The I2C Master Controller 100 ends the current write operation by sending an I2C STOP signal (P) or an I2C START signal (S) defined by the standard I2C specification.

As shown in FIG. 3, an I2C read operation includes a read address byte and one or more read operation data bytes (BYTE (1), ..., BYTE (N), unshaded). The read address byte is the first byte sent by the I2C Master Controller 100, and the one or more read operation data bytes are sent by the I2C Slave Device 200. The read address byte includes an I2C read address (ADDR) and a read operation indicator bit (R). According to the standard I2C specification, the read operation indicator bit (R) is at a high level.

In this embodiment, both the read address byte and the read operation data byte are 8 bits, wherein the read address byte includes a 7-bit I2C read address (ADDR) and a 1-bit read operation indicator bit (R). The present invention does not limit the number of bits of the read address byte and the read operation data byte. In other embodiments, the read address byte and the read operation data byte may have other numbers of bits.

When the I2C Master Controller 100 initiates an I2C read operation, the I2C Master Controller 100 first drives the I2C clock line (SCL) 700 and the I2C data line (SDA) 600 according to the standard I2C specification to generate an I2C START signal (S), then sends the read address byte. After receiving the read address byte, the I2C Slave Device 200 drives the I2C data line (SDA) 600 to generate an acknowledgment bit. According to the standard I2C specification, the acknowledgment bit can be an I2C ACK (the level of the I2C data line (SDA) 600 is low) or an I2C NAK (the level of the I2C data line (SDA) 600 is high).

When the acknowledgment bit of the read address byte is an I2C ACK, the I2C Slave Device 200 can return one or more read operation data bytes by driving the I2C data line (SDA) 600. After receiving each read operation data byte, the I2C Master Controller 100 drives the I2C data line (SDA) 600 to generate an acknowledgment bit. The acknowledgment bit of the read operation data byte can be an I2C ACK (the level of the I2C data line (SDA) 600 is low) or an I2C NAK (the level of the I2C data line (SDA) 600 is high).

According to the standard I2C specification, when the I2C Master Controller 100 sends the read address byte and the I2C Slave Device 20 returns one or more read operation data bytes, the I2C Master Controller 100 sends the number of bits contained in the read address byte by driving the I2C data line (SDA) 600, and the I2C Slave Device 200 returns the bits contained in the read operation data byte by driving the I2C data line (SDA) 600. For each bit contained in the read address byte and the read operation data byte, the I2C Master Controller 100 drives the I2C clock line (SCL) 700 to generate a clock pulse.

According to the standard I2C specification, corresponding to the acknowledgment bit of the read address byte and the acknowledgment bit of the read operation data byte, the I2C Master Controller 100 also drives the I2C clock line (SCL) 700 to generate a clock pulse. The I2C Master Controller 100 ends the current read operation by sending an I2C STOP signal (P) or an I2C START signal (S) defined by the standard I2C specification.

A cycle of an I2C write operation or an I2C read operation starts with an I2C START signal (S), but there are two ways to end it. The first way is to end with an I2C STOP signal (P), and the timing sequences are shown in FIG. 2 and FIG. 3 respectively.

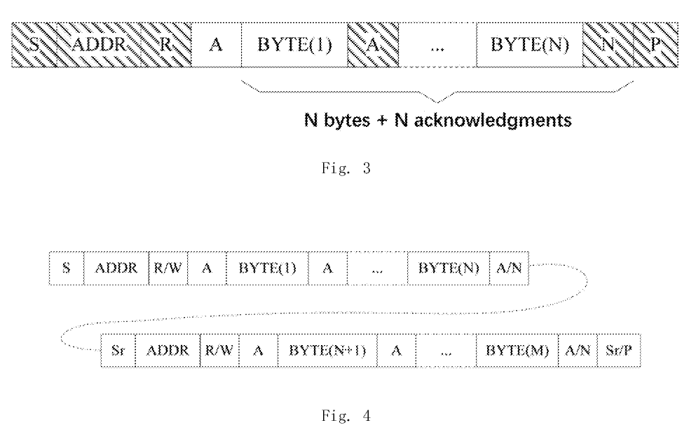

The second way is to generate a new I2C START signal (S) to enter the next I2C write operation or I2C read operation, and the timing sequence is shown in FIG. 4. The dashed line connection (such connections in other drawings) between the acknowledgment bit (A/N) and the I2C START signal (Sr) in FIG. 4 is because the timing diagram is long and not easy to describe in the same line, so it is split into multiple lines, indicating that there is a connection relationship between the two timing diagrams.

The use of any of the above ending methods will not affect the data writing method and data reading method of the present invention. For the convenience of description, the ending of an I2C operation (I2C write operation or I2C read operation) is described in the way of carrying an I2C STOP signal (P) in this embodiment.

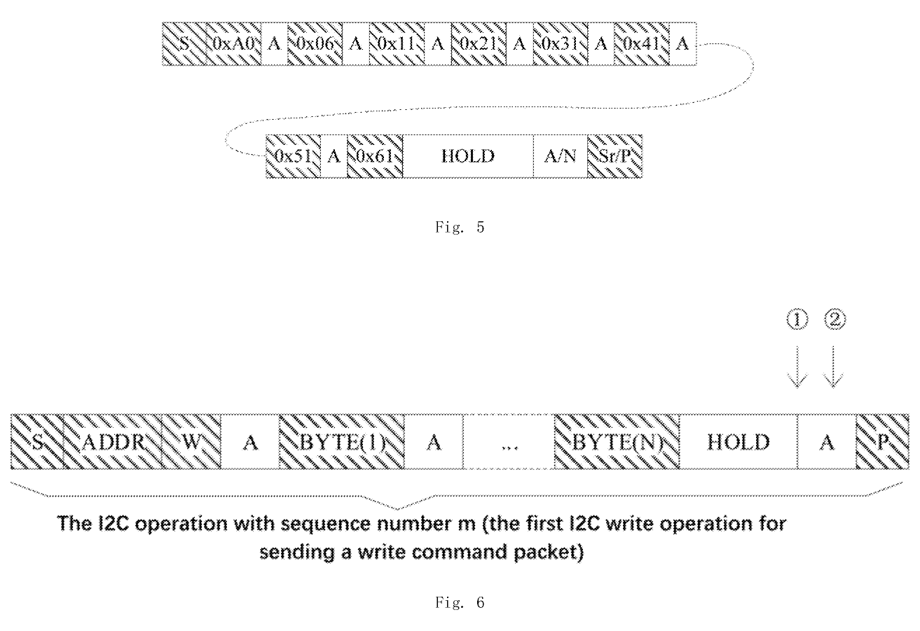

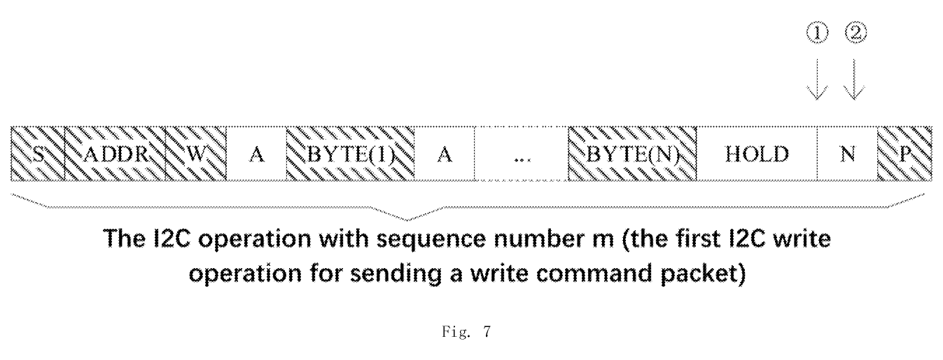

With reference to FIG. 5, the I2C Master Controller 100 initiates an I2C write operation to sequentially write 0xA0, 0x06, 0x11, 0x21, 0x31, 0x41, 0x51, 0x61 to the I2C Slave Device 200, wherein the 0xA0 byte corresponds to the write address byte, the upper 7 bits correspond to the I2C write address (ADDR) 0x50, the lower 1 bit is the write operation indicator bit (W), and the value of the write operation indicator bit (W) is 0 indicating a current write operation. The value of this byte is the binary number 10100000, that is, the hexadecimal number 0xA0. A total of 7 bytes of 0x06, 0x11, 0x21, 0x31, 0x41, 0x51, 0x61 correspond to the write operation data.

According to an embodiment of the present invention, a data reading and writing method based on an I2C slave device is provided, using the I2C interface system based on an I2C slave device for data reading and writing, comprising:

The I2C Master Controller 100 initiates a first I2C write operation and a second I2C write operation. The first I2C write operation includes a first write address byte and first write operation data, and the first write operation data includes a command packet.

The second I2C write operation includes a second write address byte and second write operation data. Both the first write address byte and the second write address byte include an I2C write address (ADDR) and a write operation indicator bit (W).

The I2C Master Controller 100 initiates a first I2C write operation and a second I2C write operation, and the I2C Slave Device 200 receives the first I2C write operation and the second I2C write operation.

When the I2C write address (ADDR) received by the I2C Slave Device 200 meets a first preset condition, the I2C write operation received by the I2C Slave Device 200 is the first I2C write operation. The I2C Slave Device 200 receives the command packet sent by the first I2C write operation, and after receiving the command packet, sends the command packet to the first functional module 300.

When the I2C write address (ADDR) received by the I2C Slave Device 200 meets a second preset condition, the I2C write operation received by the I2C Slave Device 200 is the second I2C write operation.

The present invention does not specify or limit the first preset condition or the second preset condition. In one embodiment, the I2C write address (ADDR) received by the I2C Slave Device 200 meeting the first preset condition may be that the I2C write address (ADDR) received by the I2C Slave Device 200 is in a first preset address range. The I2C write address (ADDR) received by the I2C Slave Device 200 meeting the second preset condition may be that the I2C write address (ADDR) received by the I2C Slave Device 200 is in a second preset address range.

The first preset condition or the second preset condition in the present invention may have an intersection or no intersection. If the first preset condition or the second preset condition has an intersection, it is necessary to additionally specify how to determine whether the I2C write operation received by the I2C Slave Device 200 is the first I2C write operation or the second I2C write operation when the I2C write address (ADDR) meets both the first preset condition and the second preset condition. The present invention does not limit this specification.

With reference to FIG. 5, for example, to illustrate the first preset condition, if the first preset condition is that the I2C write address (ADDR) received by the I2C Slave Device 200 is in a first preset address range, and the first preset address range includes the I2C address 0x50. When the value of the I2C write address (ADDR) byte received by the I2C Slave Device 200 is equal to the hexadecimal number 0xA0, the upper 7 bits of the I2C write address (ADDR) byte correspond to the I2C write address (ADDR) 0x50, and the I2C write address (ADDR) received by the I2C Slave Device 200 is in the first preset address range, thereby meeting the first preset condition. Then the I2C write operation received by the I2C Slave Device 200 is the first I2C write operation, 0xA0 corresponds to the first write address byte, and a total of 7 bytes of 0x06, 0x11, 0x21, 0x31, 0x41, 0x51, 0x61 correspond to the first write operation data. The first write operation data includes a command packet. The I2C Slave Device 200 receives the command packet sent by the first I2C write operation, and after receiving the command packet, sends the command packet to the first functional module 300.

The command packet comprises a write command packet and a read command packet. In the present invention, the write command packet is sent through the write operation data bytes (BYTE (1), ..., BYTE (N)). The read command packet of the present invention is also sent through the write operation data bytes (BYTE (1), ..., BYTE (N)).

For example, when the I2C Master Controller 100 sends a write command packet, the I2C Master Controller 100 initiates a first I2C write operation to send the first write address byte and one or more first write operation data bytes (BYTE (1), ..., BYTE (N)) containing the write command packet to the I2C Slave Device 200.

When the I2C Master Controller 100 sends a read command packet, the I2C Master Controller 100 initiates a first I2C write operation to send the first write address byte and one or more first write operation data bytes (BYTE (1), ..., BYTE (N)) containing the read command packet to the I2C Slave Device 200.

As shown in FIG. 5, when the I2C Slave Device 200 receives the last bit of the 0x61 byte, that is, the I2C Slave Device 200 receives the command packet, the I2C Slave Device 200 pulls down the level of the I2C clock line 500, the I2C bus is in a HOLD state (continuous low level state), and the I2C Slave Device 200 sends the command packet to the first functional module 300.

The first functional module 300 receives the command packet and executes the command, and after completing the command, returns a feedback packet to the I2C Slave Device 200. The I2C Slave Device 200 returns the information of the feedback packet to the I2C Master Controller 100.

The feedback packet of the present invention may be a first write status packet or a first read data packet. When the I2C Master Controller 100 sends a write command packet, the feedback packet is a first write status packet, and the information contained in the feedback packet is the status information of the first write status packet; when the I2C Master Controller 100 sends a read command packet, the feedback packet is a first read data packet, and the information contained in the feedback packet is the read data in the first read data packet.

In the present invention, when the I2C Slave Device 200 sends the command packet to the first functional module 300, the content in the command packet may be modified, added or deleted, which is not limited or specified by the present invention.

The first write operation data of the present invention includes a command packet. In some embodiments of the present invention, the I2C Slave Device 200 receiving the command packet means that the I2C Slave Device 200 receives the last first write operation data byte BYTE(N). In other embodiments of the present invention, if the command packet is only contained in part of the first write operation data, the command packet may be considered received after receiving all the first write operation data bytes containing the command packet.

In FIG. 5 and the following description of the present invention, the I2C Slave Device 200 receiving the command packet means that the I2C Slave Device 200 receives the last first write operation data byte BYTE(N).

According to an embodiment of the present invention, when the command packet received by the I2C Slave Device 200 is a write command packet, after receiving the write command packet, the I2C Slave Device 200 pulls down the level of the I2C clock line (SCL) 700 and sends the write command packet to the first functional module 300.

The first functional module 300 receives the write command packet and executes the write command, and after completing the write command, returns a first write status packet to the I2C Slave Device 200. The I2C Slave Device 200 returns the status information of the first write status packet to the I2C Master Controller 100.

According to an embodiment of the present invention, the I2C Slave Device 200 returns the status information of the first write status packet to the I2C Master Controller 100, comprising:

When the I2C Slave Device 200 receives the first write status packet and the status information of the first write status packet is successful, the I2C Slave Device 200 stops pulling down the level of the I2C clock line (SCL) 700 and returns an I2C ACK to the I2C Master Controller 100.

When the I2C Slave Device 200 receives the first write status packet and the status information of the first write status packet is failed, the I2C Slave Device 200 stops pulling down the level of the I2C clock line (SCL) 700 and returns an I2C NAK to the I2C Master Controller 100.

For example, as shown in FIG. 6, the I2C Master Controller 100 initiates an I2C operation (first I2C write operation) with sequence number m (m is a natural number).

As shown in FIG. 6, the I2C Master Controller 100 sends a write command packet through the first I2C write operation with sequence number m. After receiving the write command packet (after receiving BYTE(N)), the I2C Slave Device 200 pulls down the level of the I2C clock line (SCL) 700, and the I2C bus is in a HOLD state (continuous low level state).

At time ①, the I2C Slave Device 200 receives the first write status packet and the status information of the first write status packet is successful. The I2C Slave Device 200 stops pulling down the level of the I2C clock line (SCL) 700 and terminates the HOLD state (terminates the continuous low level state).

At time ②, the I2C Slave Device 200 returns an I2C ACK to the I2C Master Controller 100, and the I2C Master Controller 100 terminates the I2C operation (first I2C write operation) with sequence number m.

As shown in FIG. 7, the I2C Master Controller 100 sends a write command packet through the first I2C write operation with sequence number m. After receiving the write command packet (after receiving BYTE(N)), the I2C Slave Device 200 pulls down the level of the I2C clock line (SCL) 700, and the I2C bus is in a HOLD state (continuous low level state).

At time ①, the I2C Slave Device 200 receives the first write status packet and the status information of the first write status packet is failed. The I2C Slave Device 200 stops pulling down the level of the I2C clock line (SCL) 700 and terminates the HOLD state (terminates the continuous low level state).

At time ②, the I2C Slave Device 200 returns an I2C NAK to the I2C Master Controller 100, and the I2C Master Controller 100 terminates the I2C operation (first I2C write operation) with sequence number m.

In one embodiment, when the command packet received by the I2C Slave Device 200 is a write command packet, after receiving the write command packet, the I2C Slave Device 200 sends the write command packet to the first functional module 300.

The first functional module 300 receives the write command packet and executes the write command, and after completing the write command, returns a first write status packet to the I2C Slave Device 200. The I2C Slave Device 200 returns the first write status packet to the I2C Master Controller 100, comprising:

After the I2C Slave Device 200 receives the write command packet, if the subsequent I2C operation initiated by the I2C Master Controller 100 is a first I2C write operation, and the I2C Slave Device 200 receives the first write status packet returned by the first functional module 300 to the I2C Slave Device 200 and the status information of the first write status packet is successful, the I2C Slave Device 200 receives the subsequent first I2C write operation initiated by the I2C Master Controller 100.

If the subsequent I2C operation initiated by the I2C Master Controller 100 is a first I2C write operation, and the I2C Slave Device 200 receives the first write status packet returned by the first functional module 300 to the I2C Slave Device 200 and the status information of the first write status packet is failed, the I2C Slave Device 200 returns an I2C NAK to the I2C Master Controller 100.

If the subsequent I2C operation initiated by the I2C Master Controller 100 is a first I2C read operation, and the I2C Slave Device 200 receives the first write status packet returned by the first functional module 300 to the I2C Slave Device 200, the I2C Slave Device 200 returns the status information of the first write status packet to the I2C Master Controller 100.

When the I2C Master Controller 100 initiates an I2C read operation, if the I2C read address (ADDR) received by the I2C Slave Device 200 meets a third preset condition, the I2C read operation received by the I2C Slave Device 200 is a first I2C read operation; if the I2C read address (ADDR) received by the I2C Slave Device 200 meets a fourth preset condition, the I2C read operation received by the I2C Slave Device 200 is a second I2C read operation.

The present invention does not specify or limit the third preset condition or the fourth preset condition. In one embodiment, the I2C read address (ADDR) received by the I2C Slave Device 200 meeting the third preset condition may mean that the I2C read address (ADDR) is within a third preset address range; the I2C read address (ADDR) meeting the fourth preset condition may mean that the I2C read address (ADDR) is within a fourth preset address range.

The third preset condition and the fourth preset condition in the present invention may or may not overlap. If they overlap, additional provisions are required to determine whether the I2C read operation received by the I2C Slave Device 200 is the first I2C read operation or the second I2C read operation when the I2C read address (ADDR) meets both conditions, which is not limited by the present invention.

The first I2C read operation includes a first read address byte and first read operation data. In the present invention, the I2C Slave Device 200 may return the status information of the first write status packet to the I2C Master Controller 100 through the first read operation data, may also return the read data in the first read data packet (described below) to the I2C Master Controller 100 through the first read operation data, and may further return other status information generated by itself due to errors related to the write command packet and the read command packet to the I2C Master Controller 100 through the first read operation data.

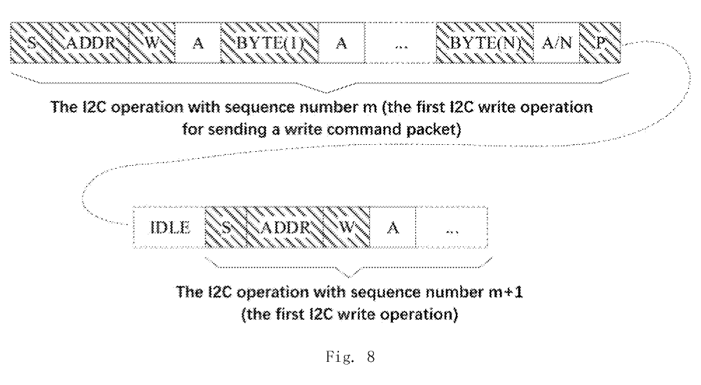

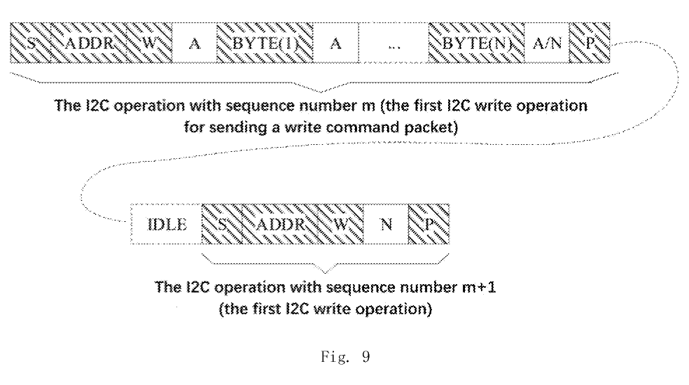

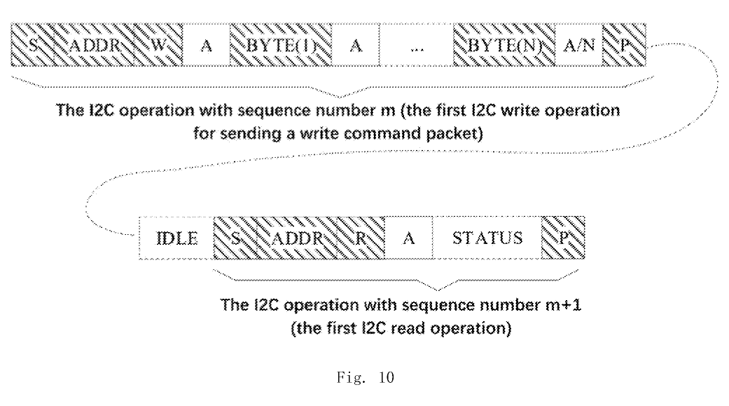

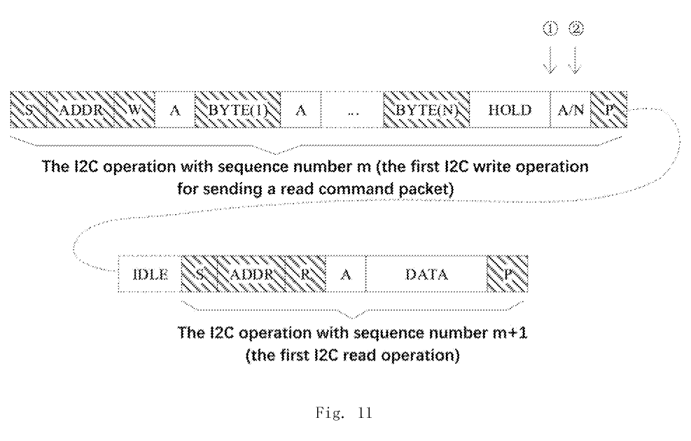

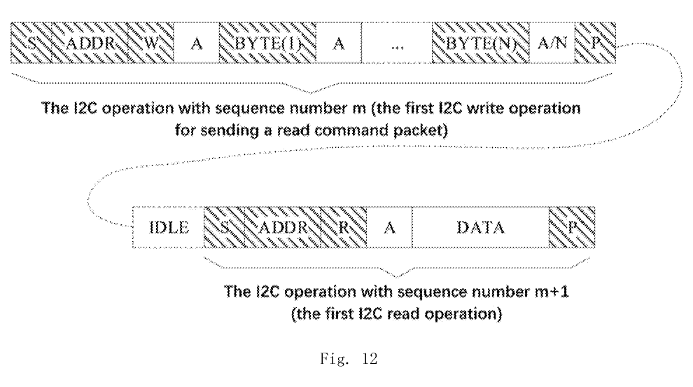

As shown in FIG. 8, FIG. 9, and FIG. 10, the I2C operation with sequence number m initiated by the I2C Master Controller 100 is a first I2C write operation for sending a write command packet to the I2C Slave Device 200. For the first N-1 first write operation data bytes (BYTE(1), ..., BYTE(N-1)), the I2C Slave Device 200 returns an I2C ACK to the I2C Master Controller 100 after each first write operation data byte is sent.

After the I2C Slave Device 200 receives the Nth first write operation data byte (BYTE(N)) (i.e., after the I2C Slave Device 200 receives the complete write command packet), the I2C Slave Device 200 may return an I2C ACK or an I2C NAK to the I2C Master Controller 100, which is selected through an agreement between the I2C Master Controller 100 and the I2C Slave Device 200. The I2C Master Controller 100 and the I2C Slave Device 200 may agree that both I2C ACK and I2C NAK after the Nth first write operation data byte (BYTE(N)) indicate the successful reception of the Nth first write operation data byte (i.e., the complete write command packet), or agree that an I2C NAK indicates the unsuccessful reception of the Nth first write operation data byte (BYTE(N)) (i.e., the incomplete reception of the write command packet). In the following description of the present invention, both I2C ACK and I2C NAK returned by the I2C Slave Device 200 to the I2C Master Controller 100 after the Nth first write operation data byte (BYTE(N)) indicate the successful reception of the Nth first write operation data byte (i.e., the complete write command packet).

After the I2C Master Controller 100 completes sending the Nth first write operation data byte (BYTE(N)), regardless of whether the I2C Slave Device 200 returns an I2C ACK or an I2C NAK to the I2C Master Controller 100, the I2C Master Controller 100 terminates the I2C operation with sequence number m (the first I2C write operation) and may choose to initiate an I2C operation with sequence number m+1 (the subsequent I2C operation).

When the I2C operation with sequence number m+1 (the subsequent I2C operation) is a first I2C write operation, if the I2C Slave Device 200 receives the first write status packet returned by the first functional module 300 to the I2C Slave Device 200 (the first write status packet corresponding to the I2C operation with sequence number m) and the status information of the first write status packet is successful, after the I2C Master Controller 100 sends the first write address byte, the I2C Slave Device 200 returns an I2C ACK to the I2C Master Controller 100 and receives the first write operation data byte sent by the I2C operation with sequence number m+1 (the subsequent I2C operation/the first I2C write operation) initiated by the I2C Master Controller 100, as shown in FIG. 8.

When the I2C operation with sequence number m+1 (the subsequent I2C operation) is a first I2C write operation, if the I2C Slave Device 200 receives the first write status packet returned by the first functional module 300 to the I2C Slave Device 200 (the first write status packet corresponding to the I2C operation with sequence number m) and the status information of the first write status packet is failed, after the I2C Master Controller 100 sends the first write address byte, the I2C Slave Device 200 returns an I2C NAK to the I2C Master Controller 100, and the Master Controller 100 terminates the initiated I2C operation with sequence number m+1 (the subsequent I2C operation/the first I2C write operation), as shown in FIG. 9.

As shown in FIG. 10, when the I2C operation with sequence number m+1 initiated by the I2C Master Controller 100 is a first I2C read operation, if the I2C Slave Device 200 receives the first write status packet returned by the first functional module 300 to the I2C Slave Device 200 (the first write status packet corresponding to the I2C operation with sequence number m), the I2C Slave Device 200 returns an I2C ACK to the I2C Master Controller 100 and returns the status information (STATUS) of the first write status packet to the I2C Master Controller 100.

In one embodiment, when the command packet received by the I2C Slave Device 200 is a read command packet, the I2C Slave Device 200 pulls down the level of the I2C clock line (SCL) 700 after receiving the read command packet and sends the read command packet to the first functional module 300.

The first functional module 300 receives the read command packet and executes the read command. After the first functional module 300 completes the read command, it returns a first read data packet to the I2C Slave Device 200, and the first read data packet includes read data. The I2C Slave Device 200 returns the read data in the first read data packet to the I2C Master Controller 100.

According to an embodiment of the present invention, the I2C Slave Device 200 returns the read data in the first read data packet to the I2C Master Controller 100, including:

When the I2C Slave Device 200 receives the first read data packet, the I2C Slave Device 200 stops pulling down the level of the I2C clock line (SCL) 700.

If the subsequent I2C operation initiated by the I2C Master Controller 100 is a first I2C read operation, the I2C Slave Device 200 returns the read data in the first read data packet to the I2C Master Controller 100.

For example, as shown in FIG. 11, the I2C Master Controller 100 initiates a first I2C write operation with sequence number m to send a read command packet to the I2C Slave Device 200. After receiving the read command packet (after receiving BYTE(N)), the I2C Slave Device 200 pulls down the level of the I2C clock line (SCL) 700, and the I2C bus is in a HOLD state (continuous low-level state).

At time ①, the I2C Slave Device 200 receives the first read data packet, stops pulling down the level of the I2C clock line (SCL) 700, and terminates the HOLD state (terminates the continuous low-level state).

At time ②, the I2C Slave Device 200 returns an I2C ACK or an I2C NAK to the I2C Master Controller 100, and the I2C Master Controller 100 terminates the I2C operation with sequence number m (the first I2C write operation).

In the present invention, the first read data packet includes data read by the first functional module 300 (read data), or status information generated by the first functional module 300 when executing the read command, or both the data read by the first functional module 300 (read data) and the status information generated by the first functional module 300 when executing the read command.

The present invention does not limit or specify whether the I2C Slave Device 200 returns an I2C ACK or an I2C NAK to the I2C Master Controller 100 after receiving the first read data packet and stopping pulling down the level of the I2C clock line. As an embodiment, the I2C Slave Device 200 may choose to stop pulling down the level of the I2C clock line 500 and return an I2C ACK to the I2C Master Controller 100 when the I2C Slave Device 200 receives the read data packet and the status information (read data) of the read data packet is successful, and stop pulling down the level of the I2C clock line 500 and return an I2C NAK to the I2C Master Controller 100 when the I2C Slave Device 200 receives the read data packet and the status information of the read data packet is failed.

If the I2C operation with sequence number m+1 initiated by the I2C Master Controller 100 (the subsequent I2C operation) is a first I2C read operation, after the I2C Slave Device 200 receives the first read address byte, the I2C Slave Device 200 returns an I2C ACK to the I2C Master Controller 100 and continues to return the read data (DATA) in the first read data packet, so that the I2C Master Controller 100 continues to execute the I2C operation with sequence number m+1 (the subsequent I2C operation/the I2C read operation).

During the I2C Master Controller 100 continuing to execute the I2C operation with sequence number m+1 (the subsequent I2C operation/the I2C read operation), the read data (DATA) is read.

In one embodiment, when the command packet received by the I2C Slave Device 200 is a read command packet, the I2C Slave Device 200 sends the read command packet to the first functional module 300 after receiving the read command packet.

The first functional module 300 receives the read command packet and executes the read command. After the first functional module 300 completes the read command, it returns a first read data packet to the I2C Slave Device 200, and the first read data packet includes read data. The I2C Slave Device 200 returns the read data in the first read data packet to the I2C Master Controller 100, including:

After the I2C Slave Device 200 receives the read command packet, if the subsequent I2C operation initiated by the I2C Master Controller 100 is a first I2C read operation, and the I2C Slave Device 200 receives the first read data packet returned by the first functional module 300 to the I2C Slave Device 200, the I2C Slave Device 200 returns the read data in the first read data packet to the I2C Master Controller 100.

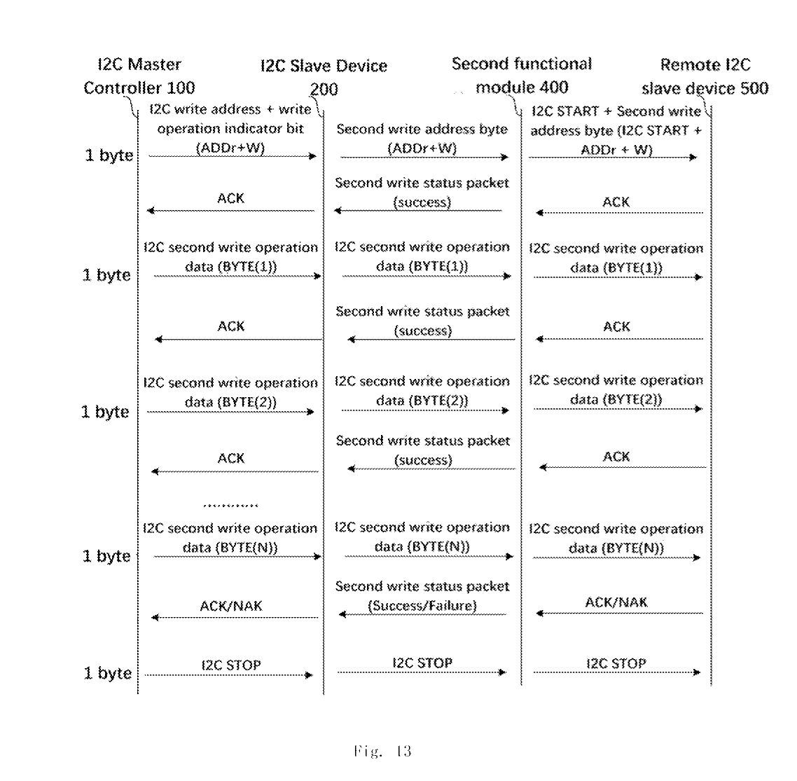

For example, as shown in FIG. 12, the I2C operation with sequence number m initiated by the I2C Master Controller 100 is a first I2C write operation for sending a read command packet to the I2C Slave Device 200. For the first N-1 first write operation data bytes (BYTE(1), ..., BYTE(N-1)), the I2C Slave Device 200 returns an I2C ACK to the I2C Master Controller 100 after each first write operation data byte is sent.

After the I2C Slave Device 200 receives the Nth first write operation data byte (BYTE(N)) (i.e., after the I2C Slave Device 200 receives the complete read command packet), the I2C Slave Device 200 may return an I2C ACK or an I2C NAK to the I2C Master Controller 100, which is selected through an agreement between the I2C Master Controller 100 and the I2C Slave Device 200. The I2C Master Controller 100 and the I2C Slave Device 200 may agree that both I2C ACK and I2C NAK after the Nth first write operation data byte (BYTE(N)) indicate the successful reception of the Nth first write operation data byte (i.e., the complete read command packet), or agree that an I2C NAK indicates the unsuccessful reception of the Nth first write operation data byte (BYTE(N)) (i.e., the incomplete reception of the read command packet). In the following description of the present invention, both I2C ACK and I2C NAK returned by the I2C Slave Device 200 to the I2C Master Controller 100 after the Nth first write operation data byte (BYTE(N)) indicate the successful reception of the Nth first write operation data byte (i.e., the complete read command packet).

If the I2C operation with sequence number m+1 initiated by the I2C Master Controller 100 (the subsequent I2C operation) is a first I2C read operation, and the I2C Slave Device 200 receives the first read data packet returned by the first functional module 300 to the I2C Slave Device 200 (the first read data packet corresponding to the I2C operation with sequence number m), after the I2C Slave Device 200 receives the first read address byte, it returns an I2C ACK to the I2C Master Controller 100 and returns the read data (DATA) in the first read data packet to the I2C Master Controller 100.

According to an embodiment of the present invention, the I2C Master Controller 100 is connected to the I2C Slave Device 200 via an I2C clock line (SCL) 700 and an I2C data line (SDA) 600. The I2C Slave Device 200 is connected to the first functional module 300, and the I2C Slave Device 200 is connected to the second functional module 400.

The I2C Master Controller 100 initiates a first I2C write operation and a second I2C write operation. The first I2C write operation includes a first write address byte and first write operation data, and the first write operation data includes a command packet.

The second I2C write operation includes a second write address byte and second write operation data. Both the first write address byte and the second write address byte include an I2C write address (ADDR) and a write operation indicator bit (W).

The I2C Master Controller 100 initiates the first I2C write operation and the second I2C write operation, and the I2C Slave Device 200 receives the first I2C write operation and the second I2C write operation.

When the I2C write address received by the I2C Slave Device 200 meets the second preset condition, the I2C Slave Device 200 receives the second I2C write operation, and after receiving each byte of the second write operation (comprising the second write address byte and each second write operation data byte), sends each received byte of the second write operation to the second functional module 400.

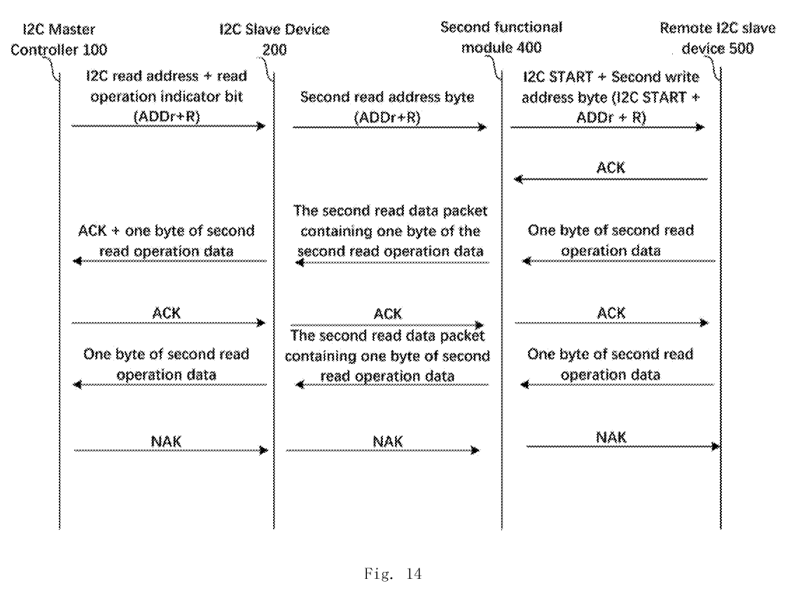

With reference to FIG. 13, for example, according to an embodiment of the present invention, the operation sent by the I2C Master Controller 100 is a second write operation. After the I2C Slave Device 200 receives each byte of the second write operation (comprising the second write address byte and the second write operation data bytes BYTE(1), ..., BYTE(N)), it sends each received byte of the second write operation to the second functional module 400. After the second functional module 400 receives each byte of the second write operation, it returns a second write status packet to the I2C Slave Device 200.

When the I2C Slave Device 200 receives the second write status packet and the status information of the second write status packet is successful, the I2C Slave Device 200 returns an I2C ACK to the I2C Master Controller 100.

When the I2C Slave Device 200 receives the second write status packet and the status information of the second write status packet is failed, the I2C Slave Device 200 returns an I2C NAK to the I2C Master Controller 100.

In the embodiment shown in FIG. 13, the status information of the second write status packet returned by the second functional module 400 after receiving the second write address byte and the second write operation data bytes BYTE(1), ..., BYTE(N-1) is successful, and the status information of the second write status packet returned by the second functional module 400 after receiving the second write operation data byte BYTE(N) is either successful or failed. According to an embodiment of the present invention, the I2C Master Controller 100 is connected to the I2C Slave Device 200 via an I2C clock line (SCL) 700 and an I2C data line (SDA) 600. The I2C Slave Device 200 is connected to the first functional module 300, the I2C Slave Device 200 is connected to the second functional module 400, and the second functional module 400 is further connected to a remote I2C slave device 500.

Further, when the I2C write address received by the I2C Slave Device 200 meets the second preset condition, the I2C Slave Device 200 receives the second write operation, and after receiving the second write address byte, sends the received second write address byte to the second functional module 400.

After receiving the second write address byte, the second functional module 400 sends an I2C START signal and the second write address byte to the remote I2C slave device 500, and receives an I2C ACK or an I2C NAK returned by the remote I2C slave device 500 to the second functional module 400.

If the remote I2C slave device 500 returns an I2C ACK to the second functional module 400, the status information of the second write status packet returned by the second functional module 400 to the I2C Slave Device 200 is successful, and the I2C Slave Device 200 returns an I2C ACK to the I2C Master Controller 100.

If the remote I2C slave device 500 returns an I2C NAK to the second functional module 400, the status information of the second write status packet returned by the second functional module 400 to the I2C Slave Device 200 is failed, and the I2C Slave Device 200 returns an I2C NAK to the I2C Master Controller 100.

In the embodiment shown in FIG. 13, the remote I2C slave device 500 returns an I2C ACK after receiving the second write address byte.

Further, after the I2C Slave Device 200 receives each second write operation data byte (BYTE(1), ..., BYTE(N)), it sends the received second write operation data byte to the second functional module 400. After the second functional module 400 receives each second write operation data byte (BYTE(1), ..., BYTE(N)), it sends each received second write operation data byte (BYTE(1), ..., BYTE(N)) to the remote I2C slave device 500, and receives an I2C ACK or an I2C NAK returned by the remote I2C slave device 500 to the second functional module 400.

If the remote I2C slave device 500 returns an I2C ACK to the second functional module 400, the status information of the second write status packet returned by the second functional module 400 to the I2C Slave Device 200 is successful, and the I2C Slave Device returns an I2C ACK to the I2C Master Controller 100.

If the remote I2C slave device 500 returns an I2C NAK to the second functional module 400, the status information of the second write status packet returned by the second functional module 400 to the I2C Slave Device 200 is failed, and the I2C Slave Device 200 returns an I2C NAK to the I2C Master Controller 100.

In the embodiment shown in FIG. 13, the remote I2C slave device 500 returns an I2C ACK after receiving the second write operation data bytes BYTE(1), ..., BYTE(N-1), and returns an I2C ACK or an I2C NAK after receiving the second write operation data byte BYTE(N). Further, as shown in FIG. 13, the I2C Master Controller 100 may also send an I2C STOP signal to the I2C Slave Device 200. After receiving the I2C STOP signal, the I2C Slave Device 200 sends the I2C STOP signal to the remote I2C slave device 500 via the second functional module 400.

According to an embodiment of the present invention, a data reading and writing method based on an I2C slave device is provided, which uses the I2C interface system based on an I2C slave device for data reading and writing, including:

The I2C Master Controller 100 initiates a first I2C read operation and a second I2C read operation. The first I2C read operation comprises a first read address byte and first read operation data.

In the present invention, the I2C Slave Device 200 returns the status information of the first write status packet to the I2C Master Controller 100 through the first read operation data, may also return the read data in the first read data packet to the I2C Master Controller 100 through the first read operation data, and may further return other status information generated by itself due to errors related to the write command packet and the read command packet to the I2C Master Controller 100 through the first read operation data.

The second I2C read operation includes a second read address byte and second read operation data. Both the first read address byte and the second read address byte include an I2C read address (ADDR) and a read operation indicator bit (R).

When the I2C read address received by the I2C Slave Device 200 meets the third preset condition, the I2C Slave Device 200 receives the first I2C read operation and returns the first read operation data to the I2C Master Controller 100.

When the I2C read address received by the I2C Slave Device 200 meets the fourth preset condition, the I2C Slave Device receives the second I2C read operation, and after receiving the second read address byte, sends the received second read address byte to the second functional module 400.

After receiving the second read address byte, the second functional module 400 returns a second read data packet to the I2C Slave Device 200. The second read data packet includes status information and/or one byte of second read operation data.

When the I2C Slave Device 200 receives the second read data packet and the information status of the second read data packet is failed, the I2C Slave Device 200 returns an I2C NAK to the I2C Master Controller 100.

When the I2C Slave Device 200 receives the second read data packet containing one byte of second read operation data, the I2C Slave Device 200 returns an I2C ACK and one byte of second read operation data to the I2C Master Controller 100.

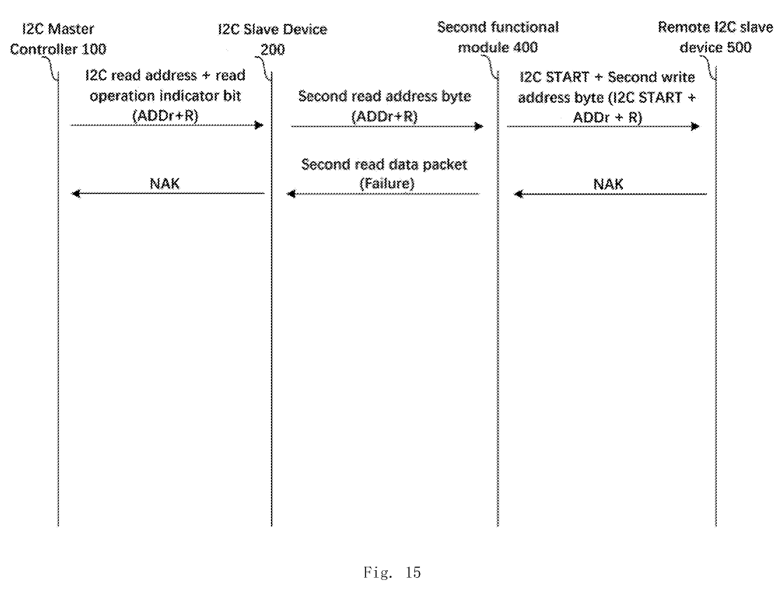

In the embodiment shown in FIG. 14, after receiving the second read address byte, the second functional module 400 returns a second read data packet containing one byte of second read operation data to the I2C Slave Device 200.

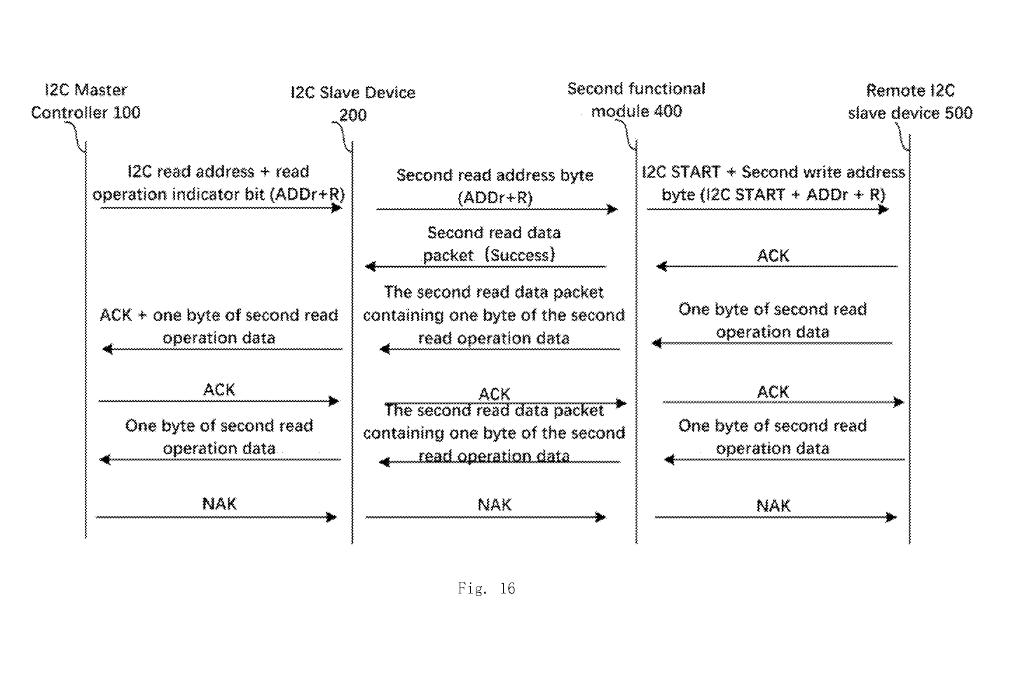

In the embodiment shown in FIG. 15, after receiving the second read address byte, the second functional module 400 returns a second read data packet with failed information status to the I2C Slave Device 200.

With reference to FIG. 14, according to an embodiment of the present invention, after the I2C Master Controller 100 receives one byte of second read operation data, it sends an I2C ACK or an I2C NAK to the I2C Slave Device 200. After receiving the I2C ACK or the I2C NAK sent by the I2C Master Controller 100, the I2C Slave Device 200 sends the received I2C ACK or I2C NAK to the second functional module 400.

After the second functional module 400 receives the I2C ACK, it returns a second read data packet containing one byte of second read operation data to the I2C Slave Device 200. After receiving the second read data packet containing one byte of second read operation data, the I2C Slave Device 200 returns one byte of second read operation data to the I2C Master Controller 100.

According to an embodiment of the present invention, the I2C Master Controller 100 is connected to the I2C Slave Device 200 via an I2C clock line (SCL) 700 and an I2C data line (SDA) 600. The I2C Slave Device 200 is connected to the first functional module 300, the I2C Slave Device 200 is connected to the second functional module 400, and the second functional module 400 is further connected to a remote I2C slave device 500.

When the I2C read address received by the I2C Slave Device 200 meets the fourth preset condition, the I2C Slave Device 200 receives the second I2C read operation, and after receiving the second read address byte, sends the received second read address byte to the second functional module 400.

After receiving the second read address byte, the second functional module 400 sends an I2C START signal and the second read address byte to the remote I2C slave device 500, and receives an I2C ACK or an I2C NAK returned by the remote I2C slave device 500 to the second functional module 400.

If the remote I2C slave device 500 returns an I2C NAK to the second functional module 400, the information status of the second read data packet returned by the second functional module 400 to the I2C Slave Device 200 is failed, and the I2C Slave Device 200 returns an I2C NAK to the I2C Master Controller 100.

If the remote I2C slave device 500 returns an I2C ACK to the second functional module 400, the second functional module 400 reads one byte of second read operation data from the remote I2C slave device 500 and returns a second read data packet containing one byte of second read operation data to the I2C Slave Device 200, and the I2C Slave Device 200 returns an I2C ACK and one byte of second read operation data to the I2C Master Controller 100.

In the embodiment shown in FIG. 14, after the remote I2C slave device 500 receives the second read address byte, it returns an I2C ACK to the second functional module 400. Then the second functional module 400 reads one byte of second read operation data from the remote I2C slave device 500 and returns a second read data packet containing one byte of second read operation data to the I2C Slave Device 200, and the I2C Slave Device 200 returns an I2C ACK and one byte of second read operation data to the I2C Master Controller 100.

In the embodiment shown in FIG. 15, after the remote I2C slave device 500 receives the second read address byte, it returns an I2C NAK to the second functional module 400. Then the second functional module 400 returns a second read data packet with failed information status to the I2C Slave Device 200, and the I2C Slave Device 200 returns an I2C NAK to the I2C Master Controller 100.

With reference to FIG. 14, according to an embodiment of the present invention, after the I2C Master Controller 100 receives one byte of second read operation data, it sends an I2C ACK or an I2C NAK to the I2C Slave Device 200. After receiving the I2C ACK or the I2C NAK sent by the I2C Master Controller 100, the I2C Slave Device 200 sends the received I2C ACK or I2C NAK to the second functional module 400.

After the second functional module 400 receives the I2C ACK, it sends an I2C ACK to the remote I2C slave device 500, reads one byte of second read operation data from the remote I2C slave device 500, and returns a second read data packet containing one byte of second read operation data to the I2C Slave Device 200. After receiving the second read data packet containing one byte of second read operation data, the I2C Slave Device 200 returns one byte of second read operation data to the I2C Master Controller 100.

After the second functional module 400 receives the I2C NAK, it sends an I2C NAK to the remote I2C slave device 500.

In one embodiment, when the I2C read address received by the I2C Slave Device 200 meets the fourth preset condition, the I2C Slave Device 200 receives the second I2C read operation, and after receiving the second read address byte, sends the received second read address byte to the second functional module 400.

After receiving the second read address byte, the second functional module 400 returns a second read data packet with failed status information to the I2C Slave Device 200 (as shown in FIG. 15), or after receiving the second read address byte, returns a second read data packet with successful status information and a second read data packet containing one byte of second read operation data to the I2C Slave Device 200. After receiving the second read data packet containing one byte of second read operation data, the I2C Slave Device 200 returns an I2C ACK and one byte of second read operation data to the I2C Master Controller 100 (as shown in FIG. 16).

As shown in FIG. 16, after the I2C Master Controller 100 receives one byte of second read operation data, the processing method is the same as that shown in FIG. 14, which is not repeated here.

According to an embodiment of the present invention, the I2C Master Controller 100 is connected to the I2C Slave Device 200 via an I2C clock line (SCL) 700 and an I2C data line (SDA) 600. The I2C Slave Device 200 is connected to the first functional module 300, the I2C Slave Device 200 is connected to the second functional module 400, and the second functional module 400 is further connected to a remote I2C slave device 500.

When the I2C read address received by the I2C Slave Device 200 meets the fourth preset condition, the I2C Slave Device 200 receives the second I2C read operation, and after receiving the second read address byte, sends the received second read address byte to the second functional module 400.

After receiving the second read address byte, the second functional module 400 sends an I2C START signal and the second read address byte to the remote I2C slave device 500, and receives an I2C ACK or an I2C NAK returned by the remote I2C slave device 500 to the second functional module 400.

If the remote I2C slave device 500 returns an I2C NAK to the second functional module 400, the second functional module 400 returns a second read data packet with failed information status to the I2C Slave Device 200, and the I2C Slave Device 200 returns an I2C NAK to the I2C Master Controller 100, as shown in FIG. 15.

If the remote I2C slave device 500 returns an I2C ACK to the second functional module 400, the second functional module 400 returns a second read data packet with successful status information to the I2C Slave Device 200, and the second functional module 400 reads one byte of second read operation data from the remote I2C slave device 500, and the second functional module 400 returns a second read data packet containing one byte of second read operation data to the I2C Slave Device 200.

After receiving the second read data packet containing one byte of second read operation data, the I2C Slave Device 200 returns an I2C ACK and one byte of second read operation data to the I2C Master Controller 100, as shown in FIG. 16.

As shown in FIG. 16, after the I2C Master Controller 100 receives one byte of second read operation data, the processing method is the same as that shown in FIG. 14, which is not repeated here.

In the present invention, the I2C Slave Device 200 may pull down the level of the I2C clock line (SCL) 700 to suspend the I2C bus (the I2C bus is in a HOLD state). In addition to the cases explicitly described above where the I2C Slave Device 200 pulls down the level of the I2C clock line (SCL) 700 to put the I2C bus in a HOLD state, the I2C Slave Device 200 may also suspend the I2C bus by pulling down the level of the I2C clock line (SCL) 700 in other cases (e.g., the I2C Slave Device 200 is internally busy) in accordance with the standard I2C specification, which is not repeated herein.

In the above description of the present invention, one first functional module 300 and one second functional module 400 are taken as examples for illustration. The present invention does not specify or limit the number and functions of the first functional module 300 and the second functional module 400. The number of the first functional module 300 and the second functional module 400 may be one or more, and the functions of the second functional module 400 and the first functional module 300 may also be integrated into the same module. The I2C Slave Device 200 is connected to this module, and when the embodiment of the present invention further includes a remote I2C slave device 500, the remote I2C slave device 500 is also connected to this module. Simple arrangement, combination, and division of the functions of the second functional module 400 and the first functional module 300 all fall within the protection scope of the present invention.

Although the embodiments of the present invention have been shown and described above, it can be understood that the above embodiments are exemplary and should not be construed as limiting the present invention. Those skilled in the art can make changes, modifications, substitutions, and variations to the above embodiments within the scope of the present invention. All such changes, modifications, substitutions, and variations are within the protection scope of the present invention.

What is claimed is:

1. An I2C interface system based on an I2C slave device, characterized by comprising an I2C Master Controller, an I2C Slave Device, a first functional module, and a second functional module;
theI2C Master Controller is connected to theI2C Slave Device via anI2C clock line and an I2C data line; theI2C Slave Device is connected to the first functional module and the second functional module.

2. A data reading and writing method based on an I2C slave device, characterized by using the I2C interface system according to claim 1 for data reading and writing, comprising:
the I2C Master Controller initiates a first I2C write operation and a second I2C write operation, wherein the first I2C write operation includes a first write address byte and first write operation data, the first write operation data includes a command packet; the second I2C write operation includes a second write address byte and second write operation data; both the first write address byte and the second write address byte include an I2C write address and a write operation indicator bit;
when the I2C write address received by the I2C Slave Device meets a first preset condition, the I2C Slave Device receives the command packet sent by the first I2C write operation, and after receiving the command packet, sends the command packet to the first functional module;
the first functional module receives the command packet and executes the command, and after completing the command, returns a feedback packet to the I2C Slave Device; the I2C Slave Device returns the information contained in the feedback packet to the I2C Master Controller;
when the I2C write address received by the I2C Slave Device meets a second preset condition, the I2C Slave Device receives the second I2C write operation, and after receiving each byte of the second write operation, sends each received byte of the second write operation to the second functional module;
after receiving each byte of the second write operation, the second functional module returns a second write status packet to the I2C Slave Device;
when the I2C Slave Device receives the second write status packet and the status information of the second write status packet is successful, the I2C Slave Device returns an I2C ACK to the I2C Master Controller;
when the I2C Slave Device receives the second write status packet and the status information of the second write status packet is failed, the I2C Slave Device returns an I2C NAK to the I2C Master Controller.

3. The data reading and writing method according to claim 2, characterized in that the command packet received by the I2C Slave Device is a write command packet, and after receiving the write command packet, the I2C Slave Device pulls down the level of the I2C clock line and sends the write command packet to the first functional module;
the first functional module receives the write command packet and executes the write command, and after completing the write command, the feedback packet returned to the I2C Slave Device is a first write status packet; the information contained in the feedback packet is the status information of the first write status packet, and the I2C Slave Device returns the status information of the first write status packet to the I2C Master Controller.

4. The data reading and writing method according to claim 3, characterized in that the I2C Slave Device returns the status information of the first write status packet to the I2C Master Controller, comprising:
when the I2C Slave Device receives the first write status packet and the status information of the first write status packet is successful, the I2C Slave Device stops pulling down the level of the I2C clock line and returns an I2C ACK to the I2C Master Controller;
when the I2C Slave Device receives the first write status packet and the status information of the first write status packet is failed, the I2C Slave Device stops pulling down the level of the I2C clock line and returns an I2C NAK to the I2C Master Controller.

5. The data reading and writing method according to claim 2, characterized in that the command packet received by the I2C Slave Device is a write command packet, and after receiving the write command packet, the I2C Slave Device sends the write command packet to the first functional module;
the first functional module receives the write command packet and executes the write command, and after completing the write command, the feedback packet returned to the I2C Slave Device is a first write status packet; the information contained in the feedback packet is the status information of the first write status packet, and the I2C Slave Device returns the status information of the first write status packet to the I2C Master Controller, comprising:
after the I2C Slave Device receives the write command packet,
if the subsequent I2C operation initiated by the I2C Master Controller is a first I2C write operation, and the I2C Slave Device receives the first write status packet returned by the first functional module and the status information of the first write status packet is successful, the I2C Slave Device receives the subsequent first I2C write operation initiated by the I2C Master Controller;
if the subsequent I2C operation initiated by the I2C Master Controller is a first I2C write operation, and the I2C Slave Device receives the first write status packet returned by the first functional module and the status information of the first write status packet is failed, the I2C Slave Device returns an I2C NAK to the I2C Master Controller;
if the subsequent I2C operation initiated by the I2C Master Controller is a first I2C read operation, and the I2C Slave Device receives the first write status packet returned by the first functional module, the I2C Slave Device returns the status information of the first write status packet to the I2C Master Controller.

6. The data reading and writing method according to claim 2, characterized in that the command packet received by the I2C Slave Device is a read command packet, and after receiving the read command packet, the I2C Slave Device pulls down the level of the I2C clock line and sends the read command packet to the first functional module;
the first functional module receives the read command packet and executes the read command, and after completing the read command, the feedback packet returned to the I2C Slave Device is a first read data packet, and the information contained in the feedback packet is the read data in the first read data packet; the I2C Slave Device returns the read data in the first read data packet to the I2C Master Controller.

7. The data reading and writing method according to claim 6, characterized in that the I2C Slave Device returns the read data in the first read data packet to the I2C Master Controller, comprising:
when the I2C Slave Device receives the first read data packet, the I2C Slave Device stops pulling down the level of the I2C clock line;
if the subsequent I2C operation initiated by the I2C Master Controller is a first I2C read operation, the I2C Slave Device returns the read data in the first read data packet to the I2C Master Controller.

8. The data reading and writing method according to claim 2, characterized in that the command packet received by the I2C Slave Device is a read command packet, and after receiving the read command packet, the I2C Slave Device sends the read command packet to the first functional module;
the first functional module receives the read command packet and executes the read command, and after completing the read command, the feedback packet returned to the I2C Slave Device is a first read data packet, and the information contained in the feedback packet is the read data in the first read data packet; the I2C Slave Device returns the read data in the first read data packet to the I2C Master Controller, comprising:
after the I2C Slave Device receives the read command packet,
if the subsequent I2C operation initiated by the I2C Master Controller is a first I2C read operation, and the I2C Slave Device receives the first read data packet returned by the first functional module, the I2C Slave Device returns the read data in the first read data packet to the I2C Master Controller.

9. The data reading and writing method according to claim 2, characterized in that the second functional module is further connected to a remote I2C slave device, and after the I2C Slave Device receives the second write address byte, it sends the received second write address byte to the second functional module;
after receiving the second write address byte, the second functional module sends an I2C START signal and the second write address byte to the remote I2C slave device, and receives an I2C ACK or I2C NAK returned by the remote I2C slave device to the second functional module;
if the remote I2C slave device returns an I2C ACK to the second functional module, the status information of the second write status packet returned by the second functional module to the I2C Slave Device is successful;
if the remote I2C slave device returns an I2C NAK to the second functional module, the status information of the second write status packet returned by the second functional module to the I2C Slave Device is failed.

10. The data reading and writing method according to claim 2, characterized in that the second functional module is further connected to a remote I2C slave device, and after receiving each byte of the second write operation data, the second functional module sends each received byte of the second write operation data to the remote I2C slave device, and after sending each byte of the second write operation data, receives an I2C ACK or I2C NAK returned by the remote I2C slave device to the second functional module;
if the remote I2C slave device returns an I2C ACK to the second functional module, the status information of the second write status packet returned by the second functional module to the I2C Slave Device is successful;
if the remote I2C slave device returns an I2C NAK to the second functional module, the status information of the second write status packet returned by the second functional module to the I2C Slave Device is failed.

11. The data reading and writing method according to claim 2, characterized in that the second functional module is further connected to a remote I2C slave device, and the I2C Master Controller can also send an I2C STOP signal to the I2C Slave Device;
after receiving the I2C STOP signal, the I2C Slave Device sends the I2C STOP signal to the remote I2C slave device via the second functional module.

12. A data reading and writing method based on an I2C slave device, characterized by using the I2C interface system according to claim 1 for data reading and writing, comprising:
the I2C Master Controller initiates a first I2C read operation and a second I2C read operation, wherein the first I2C read operation includes a first read address byte and first read operation data; the second I2C read operation includes a second read address byte and second read operation data; both the first read address byte and the second read address byte include an I2C read address and a read operation indicator bit;
when the I2C read address received by the I2C Slave Device meets a third preset condition, the I2C Slave Device receives the first I2C read operation and returns the first read operation data to the I2C Master Controller;
when the I2C read address received by the I2C Slave Device meets a fourth preset condition, the I2C Slave Device receives the second I2C read operation, and after receiving the second read address byte, sends the received second read address byte to the second functional module;
after receiving the second read address byte, the second functional module returns a second read data packet to the I2C Slave Device; wherein the second read data packet includes status information and/or one byte of second read operation data;
when the I2C Slave Device receives the second read data packet and the information status of the second read data packet is failed, the I2C Slave Device returns an I2C NAK to the I2C Master Controller;
when the I2C Slave Device receives the second read data packet containing one byte of second read operation data, the I2C Slave Device returns an I2C ACK and one byte of second read operation data to the I2C Master Controller;
after the I2C Master Controller receives one byte of second read operation data, it sends an I2C ACK or I2C NAK to the I2C Slave Device;
the I2C Slave Device sends the received I2C ACK or I2C NAK from the I2C Master Controller to the second functional module;
after the second functional module receives the I2C ACK, it returns a second read data packet containing one byte of second read operation data to the I2C Slave Device; after receiving the second read data packet containing one byte of second read operation data, the I2C Slave Device returns one byte of second read operation data to the I2C Master Controller.

13. The data reading and writing method according to claim 12, characterized in that the second functional module is further connected to a remote I2C slave device, and when the I2C read address received by the I2C Slave Device meets the fourth preset condition, the I2C Slave Device receives the second I2C read operation, and after receiving the second read address byte, sends the received second read address byte to the second functional module;
after receiving the second read address byte, the second functional module sends an I2C START signal and the second read address byte to the remote I2C slave device, and receives an I2C ACK or I2C NAK returned by the remote I2C slave device to the second functional module;
if the remote I2C slave device returns an I2C NAK to the second functional module, the information status of the second read data packet returned by the second functional module to the I2C Slave Device is failed;
if the remote I2C slave device returns an I2C ACK to the second functional module, the second functional module reads one byte of second read operation data from the remote I2C slave device and returns a second read data packet containing one byte of second read operation data to the I2C Slave Device.

14. The data reading and writing method according to claim 13, characterized in that the I2C Slave Device sends the received I2C ACK or I2C NAK from the I2C Master Controller to the second functional module;
after the second functional module receives the I2C ACK, it sends an I2C ACK to the remote I2C slave device, reads one byte of second read operation data from the remote I2C slave device, and returns a second read data packet containing one byte of second read operation data to the I2C Slave Device.

15. The data reading and writing method according to claim 13, characterized in that the I2C Slave Device sends the received I2C ACK or I2C NAK from the I2C Master Controller to the second functional module;
after the second functional module receives the I2C NAK, it sends an I2C NAK to the remote I2C slave device.

16. The data reading and writing method according to claim 12, characterized in that when the I2C read address received by the I2C Slave Device meets the fourth preset condition, the I2C Slave Device receives the second I2C read operation, and after receiving the second read address byte, sends the received second read address byte to the second functional module;
after receiving the second read address byte, the second functional module returns a second read data packet with failed status information to the I2C Slave Device, or after receiving the second read address byte, returns a second read data packet with successful status information and a second read data packet containing one byte of second read operation data to the I2C Slave Device.

17. The data reading and writing method according to claim 16, characterized in that the second functional module is further connected to a remote I2C slave device, and when the I2C read address received by the I2C Slave Device meets the fourth preset condition, the I2C Slave Device receives the second I2C read operation, and after receiving the second read address byte, sends the received second read address byte to the second functional module;
after receiving the second read address byte, the second functional module sends an I2C START signal and the second read address byte to the remote I2C slave device, and receives an I2C ACK or I2C NAK returned by the remote I2C slave device to the second functional module;
if the remote I2C slave device returns an I2C NAK to the second functional module, the second functional module returns a second read data packet with failed information status to the I2C Slave Device;
if the remote I2C slave device returns an I2C ACK to the second functional module, the second functional module returns a second read data packet with successful status information to the I2C Slave Device,
and the second functional module reads one byte of second read operation data from the remote I2C slave device,
and the second functional module returns a second read data packet containing one byte of second read operation data to the I2C Slave Device.

18. The I2C interface system according to claim 1, characterized in that the functions of the second functional module and the first functional module can be integrated into the same module.
